(19) United States
(12) Patent Application Publication
(10) Pub. No.: US 2024/0196822 A1
(43) Pub. Date: Jun. 20, 2024

(54) VERTICAL CULTIVATION SYSTEM FOR GROWING PLANTS AND METHOD FOR GROWING OF PLANTS

(71) Applicant: ARCTIC FARMING OY, Helsinki (FI)

(72) Inventor: Rodrigo PRIETO PADILLA, Helsinki (FI)

(21) Appl. No.: 18/566,758

(22) PCT Filed: Jun. 10, 2022
(86) PCT No.: PCT/FI2022/050401

§ 371 Date: Dec. 4, 2023

(30) Foreign Application Priority Data
Jun. 11, 2021 (FI) 20215684

(51) Int. Cl. A01G 31/06; A01G 7/04; A01G 9/02; A01G 9/24; A01G 27/00; A01G 27/02; A01G 31/00

(52) U.S. Cl. CPC A01G 31/06; A01G 7/045; A01G 9/025; A01G 9/247; A01G 27/008; A01G 27/02; A01G 2031/006

(57) ABSTRACT

A vertical cultivation system for growing plants. The vertical cultivation system includes one or more plant holders for holding the plant, a support wall including one or more support openings arranged to support the plant, the support wall extends transverse relative to the surface of the ground, and an irrigation arrangement arranged to provide the root part of the plants with growing liquid. The invention further relates to a method for growing of plants having an aerial part and a root part in a vertical cultivation system.

### FIELD OF THE INVENTION

The present invention relates to a vertical cultivation system and more particularly to a vertical cultivation system according to preamble of claim 1. The present invention further relates to a method for growing of plants and more particularly to a method for method for growing of plants according to preamble of claim 11.

### BACKGROUND OF THE INVENTION

In the prior art is known vertical growing systems such that roots of several plants are positioned into same space. The roots of the plants are not organized and thus, the roots form a mess. One of the problems associated with the prior art is that it is difficult to remove a few the plants during harvesting and replace those with new plantlets.

In the prior art is known to grow plants in shelfs such that plants are in a pile on the shelfs. One of the problems associated with the growing plants on the shelfs is difficulty to see and reach plants on a back portion of the shelfs. The shelfs use a space inefficiently as the plants grow in a vertical direction and a space between the shelfs must include the height of the longest plant and room to take care of the plants.

### BRIEF DESCRIPTION OF THE INVENTION

An object of the present invention is to provide a vertical cultivation system and a method for growing of plants so as to solve or at least alleviate the prior art disadvantages. The objects of the invention are achieved by a vertical cultivation system which is characterized by what is stated in the independent claim 1. The objects of the invention are further achieved by a method for growing of plants which is characterized by what is stated in the independent claim 11. The preferred embodiments of the invention are disclosed in the dependent claims.

The invention is based on the idea of providing a vertical cultivation system for growing plants having an aerial part and a root part. The vertical cultivation system comprises one or more plant holders for holding the plant. The vertical cultivation system further comprises a support wall comprising one or more support openings, The support wall extends transverse relative to the surface of the ground, and the support wall is arranged to support the one or more plant holders such that the plant extends through the one or more support openings and such that the aerial part is arranged on a first side of the support wall and the root part is arranged on a second side of the support wall. The vertical cultivation system further comprises an irrigation chamber provided on the second side of the support wall. The irrigation chamber comprising irrigation chamber walls, and the irrigation chamber walls and the support wall defining a closed irrigation space. The vertical cultivation system further comprises an irrigation arrangement arranged to provide the root part of the plants with growing liquid.

Accordingly, in the present invention, the plants are arranged to a vertical support wall. Therefore, all plants are easy to reach, and all plants are visible. The closed irrigation space enhances the growing process and enables controlling the growing environment of the root part in more detail. In this context, the term plant means cultivated plants having chlorophyll and cultivated fungi.

In one embodiment, the vertical cultivation system comprises one or more plant holders for holding the plant. The vertical cultivation system further comprises a support wall comprising one or more support openings, The support wall extends transverse relative to the surface of the ground, and the support wall is arranged to support the one or more plant holders such that the plant extends through the one or more support openings and such that the aerial part is arranged on a first side of the support wall and the root part is arranged on a second side of the support wall. The vertical cultivation system further comprises an irrigation chamber provided on the second side of the support wall. The irrigation chamber comprising irrigation chamber walls, and the irrigation chamber walls and the support wall defining a closed irrigation space. The vertical cultivation system further comprises an irrigation arrangement arranged to provide the root part of the plants with growing liquid. The vertical cultivation system comprises a growing chamber provided on the first side of the of the support wall. The growing chamber comprising growing chamber walls. The growing chamber walls comprise a growing chamber front door, and the growing chamber walls and the support wall defining a growing space. The irrigation chamber walls comprise an irrigation chamber back wall, an irrigation chamber bottom wall and an irrigation chamber top wall. The irrigation chamber walls being watertight.

This means that climatic conditions of the irrigation chamber and the growing chamber may be separately regulated because the irrigation chamber walls comprise an irrigation chamber back wall, an irrigation chamber bottom wall and an irrigation chamber top wall and the irrigation chamber walls being watertight. In this context regulating climatic conditions means for example adjusting temperature and humidity.

In one embodiment, the irrigation chamber walls comprise an irrigation chamber back wall, an irrigation chamber side wall, an irrigation chamber bottom wall, and an irrigation chamber top wall. The irrigation chamber walls being watertight.

In an alternative embodiment, the irrigation chamber walls comprise an irrigation chamber back wall, irrigation chamber side walls, an irrigation chamber bottom wall, and an irrigation chamber top wall. The irrigation chamber walls being watertight.

In one embodiment, the vertical cultivation system comprises a first climate regulation device arranged to regulate separately climatic conditions of the irrigation chamber and the growing chamber.

In an alternative embodiment, the vertical cultivation system comprises a first climate regulation device arranged to regulate climatic conditions of the irrigation chamber and a second climate regulation device arranged to regulate climatic conditions of the growing chamber.

Separate climatic conditions of the aerial part and the root part promote growth and well being of the plant.

In one embodiment, the vertical cultivation system comprises a first climate regulation device arranged to regulate separately climatic conditions of the irrigation chamber and the growing chamber and the growing chamber front door providing an access to all the one or more plant holders.

This provides separate climatic conditions of the aerial part and the root part of the plant such that all plants may be easily harvested.

In an alternative embodiment, the vertical cultivation system comprises a first climate regulation device arranged to regulate climatic conditions of the irrigation chamber and a second climate regulation device arranged to regulate climatic conditions of the growing chamber and the growing chamber front door providing an access to all the one or more plant holders.

This provides separate climatic conditions of the aerial part and the root part of the plant such that all plants may be easily harvested.

In one embodiment, the growing chamber front door is arranged to provide access to all the one or more plant holders.

In one embodiment, the vertical cultivation system comprises one or more plant holders arranged to hold the root part of the plant. The vertical cultivation system further comprises a support wall comprising one or more support openings arranged to receive the one or more plant holders, the support wall extends transverse relative to the surface of the ground, and the support wall is arranged to support the one or more plant holders such that the plant extends through the support wall and such that the aerial part is arranged on a first side of the support wall and the root part is arranged on a second side of the support wall, an irrigation chamber provided on the second side of the support wall, the irrigation chamber comprising irrigation chamber walls. The irrigation chamber walls and the support wall defining a closed irrigation space. The vertical cultivation system further comprises an irrigation arrangement arranged to provide the root part of the plants with growing liquid. The one or more plant holders arranged to hold the root part of the plant enable easily removing the plants with a root part from the vertical cultivation system.

In one embodiment of the present invention, the vertical cultivation system further comprises a growing chamber provided on the first side of the of the support wall, the growing chamber comprising growing chamber walls defining a growing space.

The growing chamber enhances the growing process and enables controlling the growing environment of the aerial part in more detail.

In another embodiment, the vertical cultivation system further comprises a growing chamber provided on the first side of the of the support wall, the growing chamber comprising growing chamber walls, the growing chamber walls comprises a growing chamber front door, and the growing chamber walls and the support wall defining a growing space.

The growing chamber enhances the growing process and enables controlling the growing environment of the aerial part in more detail such that the growing chamber front door provides an access to the plants.

In one embodiment, the growing chamber front door providing an access to all the plants.

In one embodiment of the present invention, the vertical cultivation system comprises a growing liquid reservoir.

The growing liquid reservoir retains growing liquid. Thus, no continuous flow of growing liquid is needed.

In another embodiment, the vertical cultivation system comprises a growing liquid reservoir being provided to a lower part of the irrigation chamber, the growing liquid reservoir is arranged to retain growing liquid.

The growing liquid reservoir inside the irrigation chamber retains growing liquid which is sprayed to the irrigation chamber. Thus, no separate container or continuous flow of growing liquid is needed.

In a further embodiment, the vertical cultivation system comprises a partitioning wall of the irrigation chamber arranged to provide a growing liquid reservoir underneath the partitioning wall, the growing liquid reservoir is arranged to retain growing liquid.

This provides a compact and simple structure for the growing liquid reservoir.

In another further embodiment, the vertical cultivation system comprises a growing liquid reservoir above the closed irrigation space, the growing liquid reservoir is arranged to retain growing liquid.

Growing liquid may be arranged to use gravity for irrigating the plants.

In a yet further embodiment, the vertical cultivation system comprises a separate growing liquid reservoir arranged to retain growing liquid.

This provides a growing liquid reservoir which may be freely positioned.

In one embodiment of the present invention, the irrigation arrangement comprises one or more growing liquid discharge openings arranged to spray growing liquid in the closed irrigation space.

The sprayed growing liquid efficiently irrigates the root part of the plants.

In one embodiment of the present invention, the irrigation arrangement comprises an irrigation pipe comprising an irrigation pipe wall, the irrigation arrangement comprises one or more growing liquid discharge openings arranged to spray growing liquid in the closed irrigation space, and the one or more growing liquid discharge openings are provided to an irrigation pipe wall.

This provides a simple structure for the one or more growing liquid discharge openings.

In one embodiment, the vertical cultivation system comprises a liquid circulation arrangement comprising a circulation pipe. The circulating pipe comprises an irrigating pipe comprising an irrigation pipe wall, and the one or more growing liquid discharge openings are provided to an irrigation pipe wall. This provides a simple structure for the one or more growing liquid discharge openings. In another embodiment, the irrigation arrangement comprises one or more growing liquid discharge openings arranged to spray growing liquid in the closed irrigation space, the one or more growing liquid discharge openings are provided above the one or more plant holders.

The sprayed growing liquid and an excessive growing liquid which flows down efficiently irrigates the root part of the plants.

In a further embodiment, the irrigation arrangement comprises one or more growing liquid discharge openings arranged to spray growing liquid in the closed irrigation space, the one or more growing liquid discharge openings are provided beside the one or more plant holders.

This enables directing the sprayed growing liquid directly to the root part of all plants.

In another further embodiment, the irrigation chamber walls comprise an irrigation chamber top wall, the irrigation arrangement comprises one or more growing liquid discharge openings arranged to spray growing liquid in the closed irrigation space, and the one or more growing liquid discharge openings are arranged in connection to the irrigation chamber top wall.

The sprayed growing liquid and an excessive growing liquid which flows down efficiently irrigates the root part of the plants and the irrigation chamber top wall provides a simple way to support the one or more growing liquid discharge openings.

In a yet further embodiment, the irrigation chamber walls comprise an irrigation chamber back wall, the irrigation arrangement comprises one or more growing liquid discharge openings arranged to spray growing liquid in the closed irrigation space, and the one or more growing liquid discharge openings are arranged in connection to the irrigation chamber back wall.

This enables directing the sprayed growing liquid directly to the root part of all plants and the irrigation chamber back wall provides a simple way to support the one or more growing liquid discharge openings.

In a yet further embodiment, the irrigation chamber walls comprise an irrigation chamber side wall, the irrigation arrangement comprises one or more growing liquid discharge openings arranged to spray growing liquid in the closed irrigation space, and the one or more growing liquid discharge openings are arranged in connection to the irrigation chamber side wall.

This enables directing the sprayed growing liquid directly to the root part of most plants and the irrigation chamber side wall provides a simple way to support the one or more growing liquid discharge openings.

In a yet further embodiment, the irrigation arrangement comprises a misting device arranged to provide the root part of the plants with misted growing liquid.

In one embodiment, the misting device comprises an ultrasonic device.

In one embodiment, the misting device comprises an ultrasonic humidifier.

The misted growing liquid spread efficiently to all roots. Misted growing liquid has smaller diameter than a droplet. A droplet having a diameter between 0.0001 and 0.005 cm.

In one embodiment of the present invention, the one or more growing liquid discharge openings comprise a nozzle.

In one embodiment of the present invention, the one or more growing liquid discharge openings comprise a nozzle comprising a nozzle head arranged to spray growing liquid.

The nozzle head disperses growing liquid.

In another embodiment, the one or more growing liquid discharge openings comprise a nozzle head arranged to spray misted growing liquid.

Accordingly, the nozzle head disperses growing liquid such that the misted growing liquid spread efficiently to all roots.

In one embodiment of the present invention, the vertical cultivation system comprises a liquid circulation arrangement arranged to supply growing liquid from the growing liquid reservoir to the irrigation arrangement.

The circulation arrangement enables efficient use of growing liquid.

In another embodiment, the vertical cultivation system comprises a liquid circulation arrangement arranged to supply growing liquid from the growing liquid reservoir to the irrigation arrangement, and the growing liquid reservoir is arranged to collect excessive growing liquid sprayed into the irrigation chamber.

The circulation arrangement enables efficient use of growing liquid and efficient collection of the excessive growing liquid.

In a further embodiment, the vertical cultivation system comprises a liquid circulation arrangement arranged to supply growing liquid from the growing liquid reservoir to the irrigation arrangement, the growing liquid reservoir is arranged to collect excessive growing liquid sprayed into the irrigation chamber, and the vertical cultivation system comprises a growing liquid inlet arrangement arranged to supply additional growing liquid into the vertical cultivation system.

The inlet arrangement enables adding growing liquid to the system and thus the growing liquid may be added to the system or to the growing liquid reservoir when needed.

In a yet further embodiment, the vertical cultivation system comprises a liquid circulation arrangement arranged to supply growing liquid from the growing liquid reservoir to the irrigation arrangement, the growing liquid reservoir is arranged to collect excessive growing liquid sprayed into the irrigation chamber, the vertical cultivation system further comprises a growing liquid source, and the vertical cultivation system further comprises a growing liquid inlet arrangement arranged to supply additional growing liquid from the growing liquid source into the vertical cultivation system, the vertical cultivation system comprises a surface level detector arranged to detect a surface level of the growing liquid inside the growing liquid reservoir, the vertical cultivation system comprises a switch arranged to open the growing liquid inlet arrangement when the surface level of the growing liquid inside the growing liquid reservoir being decreased to a predefined level.

Accordingly, the vertical cultivation system is all the time automatically provided with enough growing liquid.

In one embodiment of the present invention, the growing chamber walls comprise a transparent portion or translucent portion.

Accordingly, it is possible to see the plants inside the growing chamber.

In another embodiment, the growing chamber walls comprises a transparent portion.

Accordingly, it is possible to clearly see the plants inside the growing chamber.

In a further embodiment, the growing chamber walls comprises a translucent portion.

Accordingly, it is possible to see the plants inside the growing chamber such that the translucent portion blocks harmful light radiation.

In a yet further embodiment, irrigation chamber walls and the support wall defining a closed irrigation space being opaque.

Accordingly, the root part of the plants is arranged to grow in dark.

In a yet further embodiment, the growing chamber walls comprise a transparent portion or translucent portion and the support wall being opaque.

Accordingly, the root part of the plants is arranged to be in dark and the aerial part of the plant is arranged to be visible.

In a yet further embodiment, the growing chamber walls comprises a transparent portion and the support wall being opaque.

Accordingly, the root part of the plants is arranged to be in dark and the aerial part of the plant is arranged to be clearly visible.

In a yet further embodiment, the growing chamber walls comprises a translucent portion and the support wall being opaque.

Accordingly, the root part of the plants is arranged to be in dark and the aerial part of the plant is arranged to be visible such that the translucent portion blocks harmful light radiation.

In a yet further embodiment, the growing chamber walls irrigation chamber walls, and the support wall being opaque.

Accordingly, this provides a fully control of illumination of the plants.

In one embodiment of the present invention, the vertical cultivation system comprises a growing light arrangement arranged to illuminate the aerial part of the plants.

Accordingly, the plants are provided with light when the environment is too dark for the plants. In another embodiment, the vertical cultivation system comprises a growing light arrangement arranged to illuminate the aerial part of the, the growing light arrangement being elongated, and the growing light arrangement extends in a direction parallel relative to support wall.

Accordingly, the plants are provided with light when the environment is too dark for the plants such that many of the plants are equally illuminated.

In a further embodiment, the irrigation chamber comprises an irrigation chamber bottom wall and an irrigation chamber top wall, the vertical cultivation system having a longitudinal direction extending in a direction between the irrigation chamber bottom wall and the irrigation chamber top wall, the vertical cultivation system comprises a growing light arrangement arranged to extend parallel to the longitudinal direction.

Accordingly, the plants are provided with light when the environment is too dark for the plants such that many of the plants are illuminated with light beams extending in a direction horizontal.

In this context a direction horizontal means a direction which is inclined between −10 to 10 degrees from a horizontal plane.

The horizontal plane extending in a direction of the surface of the ground.

Light beams extending in a direction horizontal encourage plants to grow in a direction horizontal. This means that the plants in the vertical cultivation system grow in direction horizontal.

In a yet further embodiment, the irrigation chamber comprises an irrigation chamber bottom wall and an irrigation chamber top wall, the vertical cultivation system having a longitudinal direction extending in a direction between the irrigation chamber bottom wall and the irrigation chamber top wall, the vertical cultivation system comprises a growing light arrangement comprising one or more light sources arranged to extend parallel to the longitudinal direction.

Accordingly, the light source provides plants with light when the environment is too dark for the plants such that many of the plants are illuminated with light beams extending in a direction horizontal.

In a yet further embodiment, the vertical cultivation system comprises the growing light arrangement comprising one or more light sources, the one or more light sources are arranged to provide the plants with light beams such that the light beams having a light beam upright angle between the light beams and the support wall, and more than 60% of the plants being illuminated with the light beams having the light beam upright angle between 70 to 110 degrees.

Accordingly, the light source provides plants with light when the environment is too dark for the plants such that many of the plants are illuminated with light beams extending in a direction horizontal.

In a yet further embodiment, the vertical cultivation system comprises the growing light arrangement comprising one or more light sources, the one or more light sources are arranged to provide the plants with light beams such that the light beams having a light beam upright angle between the light beams and the support wall, and the plants are illuminated with the light beams having the light beam upright angle between 70 to 110 degrees.

Accordingly, the light source provides plants with light when the environment is too dark for the plants such that most of the plants are illuminated with light beams extending in a direction horizontal.

In a yet further embodiment, the irrigation chamber comprises an irrigation chamber bottom wall and an irrigation chamber top wall, the vertical cultivation system having a longitudinal direction extending in a direction between the irrigation chamber bottom wall and the irrigation chamber top wall, the vertical cultivation system comprises a growing light arrangement comprising one or more light sources arranged to extend parallel to the longitudinal direction, the one or more light sources are arranged to provide the plants with light beams, the light beams having a light beam upright angle between the light beams and the support wall and more than 60% of the plants being illuminated with the light beams having the light beam upright angle between 70 to 110 degrees.

Accordingly, the light source provides plants with light when the environment is too dark for the plants such that many of the plants are illuminated with light beams extending in a direction horizontal.

In a yet further embodiment, the irrigation chamber comprises an irrigation chamber bottom wall and an irrigation chamber top wall, the vertical cultivation system having a longitudinal direction extending in a direction between the irrigation chamber bottom wall and the irrigation chamber top wall, the vertical cultivation system comprises a growing light arrangement comprising one or more light sources arranged to extend parallel to the longitudinal direction, the one or more light sources are arranged to provide the plants with light beams, the light beams having a light beam upright angle between the light beams and the support wall, the light beam upright angle being between 70 to 110 degrees.

Accordingly, the light source provides plants with light when the environment is too dark for the plants such that many of the plants are illuminated with light beams extending in a direction horizontal.

In a yet further embodiment, the irrigation chamber comprises an irrigation chamber bottom wall and an irrigation chamber top wall, the vertical cultivation system having a longitudinal direction extending in a direction between the irrigation chamber bottom wall and the irrigation chamber top wall, the vertical cultivation system comprises a growing light arrangement comprising one or more light sources arranged to extend parallel to the longitudinal direction, the one or more light sources are arranged to provide the plants with light beams, the light beams extending in a direction horizontal.

Accordingly, the light source provides plants with light when the environment is too dark for the plants such that the plants are illuminated with light beams extending in a direction horizontal.

In a yet further embodiment, the irrigation chamber comprises an irrigation chamber bottom wall and an irrigation chamber top wall, the vertical cultivation system having a longitudinal direction extending in a direction between the irrigation chamber bottom wall and the irrigation chamber top wall, the vertical cultivation system comprises a growing light arrangement comprising one or more light sources arranged to extend parallel to the longitudinal direction, the one or more light sources are arranged to provide the plants with light beams, and more than 60% of the plants being illuminated with the light beams extending in a direction horizontal.

Accordingly, the light source provides plants with light when the environment is too dark for the plants such that most of the plants are illuminated with light beams extending in a direction horizontal.

In one embodiment, the growing light arrangement comprises a light source.

Accordingly, the light source provides plants with light when the environment is too dark for the plants.

In a yet further embodiment, the vertical cultivation system comprises a growing light arrangement facing toward the first side of the support wall for illuminating the aerial part of the plants.

Accordingly, the growing light arrangement provides plants with light when the environment is too dark for the plants.

In one embodiment, the growing light arrangement is arranged beside the first side of the support wall.

In one embodiment, the growing light arrangement comprises a free-standing support.

Accordingly, the growing light arrangement rests on its own support without an attachment to the support wall and to the growing chamber walls.

In one embodiment, the growing light arrangement is fixed to the support wall.

Accordingly, the support wall is arranged to support the growing light arrangement.

In one embodiment, the growing light arrangement is fixed to the growing chamber walls.

Accordingly, the growing chamber walls are arranged to support the growing light arrangement.

In one embodiment, the growing light arrangement is arranged to extend in a horizontal direction.

In one embodiment, the growing light arrangement is arranged to extend in a vertical direction.

In one embodiment, the growing light arrangement is arranged to extend in a direction transverse to a horizontal direction.

In one embodiment, the growing light arrangement comprises one or more round lights sources.

Accordingly, each of the one or more light sources is arranged to illuminate a round area.

In one embodiment, the growing light arrangement comprises one or more elongated lights sources.

Accordingly, each of the one or more elongated lights sources is arranged to illuminate an elongated area.

In one embodiment, the growing light arrangement comprises a light source and a timing device arranged to turn on the light source at intervals.

Accordingly, the light source provides plants with light when the environment is too dark for the plants and when the plants need illumination.

Accordingly, the light source provides plants with light when the environment is too dark for the plants.

In one embodiment, the growing light arrangement comprises a light source arranged to be turned on constantly.

Accordingly, the light source provides plants with light when the environment is too dark for the plants.

In one embodiment of the present invention, the growing light arrangement comprises a light source rich in red light,

The red light stimulates plant growth. The light source may comprise any type of bulb such as incandescent, fluorescent lights, high-intensity discharge lamps (HID), light-emitting diodes (LED), organic light-emitting diodes (OLED) or laser.

In another embodiment, the growing light arrangement comprises a light source rich in red and blue light.

The light rich in red and blue light promote compact growth of plants.

In one embodiment, the light source emits 80 to 90 percent red light and 10 to 20 percent blue light.

In a further embodiment, the growing light arrangement comprise a light source rich in red light, and the light source rich in red light is arranged to be turned on during nights.

Human eyes do not respond well to the colour red. Accordingly, the red light is turned on when the human beings do not operate with the vertical cultivation system.

In a yet further embodiment, the growing light arrangement comprise a light source rich in red and blue light, and the light source rich in red and blue light is arranged to be turned on during nights.

Human eyes do not respond well to the colour red and blue. Accordingly, the red and blue light is turned on when the human beings do not operate with the vertical cultivation system.

In a yet further embodiment, the growing light arrangement comprise a light source rich in red light, and the light source rich in red light is arranged to be turned off when the growing chamber front door is in an open position.

Human eyes do not respond well to the colour red. Accordingly, the red light is turned on when the human beings do not operate with the vertical cultivation system.

In a yet further embodiment, the growing light arrangement comprise a light source rich in red and blue light, and the light source rich in red and blue light is arranged to be turned off when the growing chamber front door is in an open position.

In a yet further embodiment, the growing light arrangement comprise a light source rich in red and blue light, and the light source rich in red and blue light is arranged to be turned on during nights.

In one embodiment of the present invention, the plants having the root part exposed to growing liquid.

This decreases water usage in cultivation.

In another embodiment, the plants having a consumable aerial part.

Accordingly, the aerial part of the plants is arranged to grow in a direction horizontal.

In a further embodiment, the plants having the root part exposed to growing liquid and the plants having a consumable aerial part.

In a yet further embodiment, the plants having a consumable aerial part, and the plants being in different growth stages.

Accordingly, the plants are partially harvested according to demand.

In a yet further embodiment, the plants having the root part exposed to growing liquid, the plants having a consumable aerial part, and the plants being in different growth stages between plantlet and harvest.

Accordingly, the plants are partially harvested according to demand and new plantlets are inserted after harvesting.

In a yet further embodiment, the plants having the root part exposed to growing liquid, the plants having a consumable aerial part, and the plants being different species.

The vertical cultivation system does not have shelfs which limit growing different plants having a different height. In one embodiment, the one or more plant holders are provided to the support wall.

In another embodiment, the one or more plant holders being an integral part of the support wall.

This reduces a number of parts of cultivation system.

In one embodiment, the one or more plant holders being removable from the system.

Accordingly, the plant may be removed easily with most of the roots.

In a further embodiment, the one or more plant holders comprise a root container.

The plant may be removed easily with most of the roots.

In one embodiment, the root container comprises a bag.

Accordingly, the plant may be removed easily with most of the roots such that the root container has a light structure.

In one embodiment, the root container comprises a box.

Accordingly, the plant may be removed easily with most of the roots such that the root container has a stiff structure.

In one embodiment, the one or more plant holders comprise a root container comprising one or more irrigation openings and a plant support.

The one or more irrigation openings provide to the growing liquid an efficient route inside the one or more plant pots one or more plant holders and the plants are supported on the one or more plant holders.

In one embodiment, the one or more plant holders comprise a holder media.

The holder media provides a support for the roots even if the system being soilless.

In one embodiment of the present invention, the one or more plant holders comprise one or more irrigation openings.

The one or more irrigation openings provide to the growing liquid an efficient route inside the one or more plant holders.

In another embodiment, the one or more plant holders comprise a plant support.

Accordingly, the plants are supported on the one or more plant holders.

In a further embodiment, the one or more plant holders comprise one or more irrigation openings and a plant support.

The present invention further relates to a method for growing of plants having an aerial part and a root part in a vertical cultivation system. The vertical cultivation system comprises one or more plant holders for holding the plant. The vertical cultivation system further comprises a support wall comprising one or more support openings, the support wall extends transverse relative to the surface of the ground, and the support wall is arranged to support the one or more plant holders such that the plant extends through the support wall and such that the aerial part is arranged on a first side of the support wall and the root part is arranged on a second side of the support wall. The vertical cultivation system further comprises an irrigation chamber provided on the second side of the of the support wall, the irrigation chamber comprising irrigation chamber walls, and the irrigation chamber walls and the support wall defining a closed irrigation space. The vertical cultivation system further comprises an irrigation arrangement arranged to provide the root part of the plants with growing liquid. The method according to the present invention comprises inserting the plants to the one or more support openings of the support wall, irrigating the root part of the plant with the irrigation arrangement, and harvesting.

During the cultivation growing liquid is sprayed to the root part of the plant. The plants are supported with plants pots which are inserted to a vertical support wall.

In one embodiment, a method for growing of plants having an aerial part and a root part in a vertical cultivation system. The vertical cultivation system comprises one or more plant holders for holding the plant. The vertical cultivation system further comprises a support wall comprising one or more support openings, the support wall extends transverse relative to the surface of the ground, and the support wall is arranged to support the one or more plant holders such that the plant extends through the support wall and such that the aerial part is arranged on a first side of the support wall and the root part is arranged on a second side of the support wall. The vertical cultivation system further comprises an irrigation chamber provided on the second side of the of the support wall, the irrigation chamber comprising irrigation chamber walls, and the irrigation chamber walls and the support wall defining a closed irrigation space. The vertical cultivation system comprises a growing chamber provided on the first side of the of the support wall, the growing chamber comprising growing chamber walls, the growing chamber walls comprise a growing chamber front door, and the growing chamber walls and the support wall defining a growing space. The irrigation chamber walls comprise an irrigation chamber back wall, an irrigation chamber bottom wall and an irrigation chamber top wall. The irrigation chamber walls being watertight. The vertical cultivation system further comprises an irrigation arrangement arranged to provide the root part of the plants with growing liquid. The method according to the present invention comprises inserting the plants to the one or more support openings of the support wall, irrigating the root part of the plant with the irrigation arrangement, and harvesting.

This means that climatic conditions of the irrigation chamber and the growing chamber may be separately regulated because the irrigation chamber walls comprise an irrigation chamber back wall, an irrigation chamber bottom wall and an irrigation chamber top wall and the irrigation chamber walls being watertight. In this context regulating climatic conditions means for example adjusting temperature and humidity.

In one embodiment, the irrigation chamber walls comprise an irrigation chamber back wall, an irrigation chamber side wall, an irrigation chamber bottom wall, and an irrigation chamber top wall. The irrigation chamber walls being watertight.

In an alternative embodiment, the irrigation chamber walls comprise an irrigation chamber back wall, irrigation chamber side walls, an irrigation chamber bottom wall, and an irrigation chamber top wall. The irrigation chamber walls being watertight.

In one embodiment, the vertical cultivation system comprises a first climate regulation device arranged to regulate separately climatic conditions of the irrigation chamber and the growing chamber.

In an alternative embodiment, the vertical cultivation system comprises a first climate regulation device arranged to regulate climatic conditions of the irrigation chamber and a second climate regulation device arranged to regulate climatic conditions of the growing chamber.

Separate climatic conditions of the aerial part and the root part promote growth and well being of the plant.

In one embodiment, the step of inserting the plants to the one or more support openings comprises inserting the plants to the one or more support openings of the plant of the support wall.

In one embodiment the method comprises regulating separately climatic conditions of the irrigation chamber and the growing chamber.

Separate climatic conditions of the aerial part and the root part promote growth and well being of the plant.

In one embodiment of the present invention, the step harvesting further comprises removing between 0.1 to 10% of the one or more plant holders with a plant from the vertical cultivation system for providing a partially harvested vertical cultivation system comprising one or more harvested support openings.

Accordingly, removing some of one or more plant holders having the root part of the plants is simple and the rest of the plants may continue growing.

In another embodiment, removing between 0.1 to 30% of the one or more plant holders with a plant from the vertical cultivation system for providing a partially harvested vertical cultivation system comprising one or more harvested support openings.

Accordingly, removing some of one or more plant holders having the root part of the plants is simple and the rest of the plants may continue growing.

In one embodiment of the present invention, the method comprises picking between 0.1 to 10% of plants for providing a partially harvested vertical cultivation system.

Accordingly, removing some of the plants are harvested such that the rest of the plants may continue growing.

In one embodiment of the present invention, the method comprises picking between 0.1 to 30% of the plants for providing a partially harvested vertical cultivation system.

Accordingly, removing some of the plants are harvested such that the rest of the plants may continue growing.

In one embodiment of the present invention, the method comprises after harvesting a step inserting one or more plant holders to the one or more harvested support openings.

Accordingly, removing one or more plant holders leave an open space in the closed irrigation space such that it is simple to insert a new plantlet to the vertical cultivation system and the rest plants may continue growing.

In another embodiment, the vertical cultivation system comprises one or more support opening covers, and the method comprises after harvesting a step covering the one or more harvested support openings with the one or more support opening covers.

Accordingly, the one or more harvested support openings are covered without a new plantlet.

In a further embodiment, some of the one or more harvested support openings are covered with one or more support opening covers and the one or more plant holders are inserted to the rest of the one or more harvested support openings.

In one embodiment, the plants having the root part exposed to growing liquid.

In an alternative embodiment, the plants having the root part exposed to growing liquid and the plants having a consumable aerial part.

In another alternative embodiment, the plants having a consumable aerial part.

In a yet another alternative embodiment, the plants having a consumable aerial part, and the plants being in different growth stages.

In a yet further embodiment, the plants having the root part exposed to growing liquid, the plants having a consumable aerial part, and the plants being in different growth stages between plantlet and harvest.

In a yet further alternative embodiment, the plants having the root part exposed to growing liquid, the plants having a consumable aerial part, and the plants and the plants being different species.

In one embodiment of the present invention, the method being carried out with any of above disclosed vertical cultivation system.

An advantage of the invention is that all plants are visible such that it is easy to see which plants are in harvesting stage. It is easy to remove an individual plant as a root part of the plants are positioned in plants pots. Further it is easy to insert a new plant pot having a plantlet into the system. Thus, the invention advances partial harvesting. Furthermore, efficient utilization of growing liquid is achieved.

### BRIEF DESCRIPTION OF THE DRAWINGS

The invention is described in detail by means of specific embodiments with reference to the enclosed drawings, in which:

FIGS. 1,2,3,4,5 and 6 show schematically a side view of a vertical cultivation system according to different embodiments of the present invention;

FIGS. 7, 8 and 9 show schematically a top view of a vertical cultivation system according to different embodiments of the present invention;

FIG. 10 shows schematically a front view of a plant holder of a vertical cultivation system according to one embodiment of present invention;

FIG. 11 shows a side view of the plant holder of FIG. 10;

FIG. 12 shows schematically a front view of a vertical cultivation system according to one embodiment of the present invention;

FIG. 13 shows schematically a side view of a plan holder of a vertical cultivation system according to one embodiment of present invention; and

FIG. 14 shows schematically a front view of a vertical cultivation system according to one embodiment of the present invention.

### DETAILED DESCRIPTION OF THE INVENTION

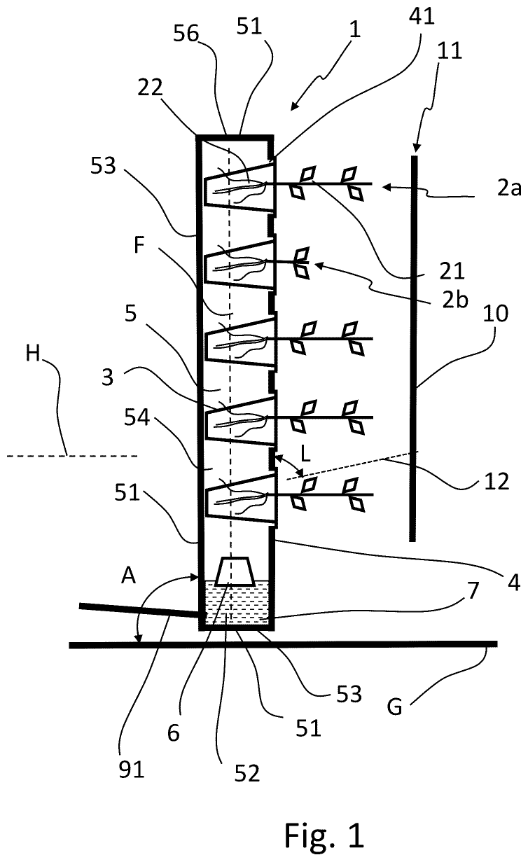

FIG. 1 shows a side view of a vertical cultivation system according to one embodiment of the present invention. The vertical cultivation system 1 is for growing plants 2a, 2b having an aerial part 21 and a root part 22.

In the vertical cultivation system 1 the root part 22 of the plants 2 are provided with growing liquid 7. Growing liquid 7 is nutrient rich water solution.

In one embodiment the plants 2a, 2b having the root part 22 exposed to growing liquid 7.

In one embodiment the root part 22 of the plants are physically supported by an inert medium such as perlite, gravel, or other substrates.

In a preferred embodiment, the plants 2a, 2b having a consumable aerial part 21.

The consumable aerial part 21 may comprise for instance a mushroom, a berry, a flower, an herb, a fruit, or a lettuce.

In a preferable embodiment, the consumable aerial part 21 comprises a leafy green.

In this context a leafy green means a plant having leaves which may be eaten.

In one embodiment the plants 2a and 2b being in different growth stages.

In a preferable embodiment, the plants 2a and 2b being in different growth stages between plantlet and harvest.

In this context a plantlet means an undeveloped plant.

In one embodiment, the plants 2a, 2b being different species. In other words, the plants 2a and 2b being different kind of plants.

The vertical cultivation system 1 comprises one or more plant holders 3 for holding the root part 21 of the plants 2a,2b.

In one embodiment, the one or more plant holders 3 are arranged to enclose the root part 21 of the plants 2a,2b such the aerial part 21 of the plants 2a,2b is arranged to extend outside the one or more plant holders 3.

The vertical cultivation system 1 further comprises a support wall 4 comprising one or more support openings 41 arranged to receive the one or more plant holders 3, the support wall 4 extends transverse relative to the surface of the ground G, and the support wall 4 is arranged to support the one or more plant holders 3 such that the plant 2a, 2b extends through the support wall 4 and such that the aerial part 21 is arranged on a first side of the support wall 4 and the root part 22 is arranged on a second side of the support wall 4.

In this context the vertical cultivation system means that the cultivation system 1 may be inclined between 0 to 20 degrees from a vertical plane.

In one embodiment, the support wall 4 is arranged such that a support wall angle A between the surface of the ground G and the support wall 4 being between 70 to 110 degrees.

In one embodiment the support wall 4 extends in a direction perpendicular to the surface of the ground G.

The vertical cultivation system 1 further comprises an irrigation chamber 5 provided on the second side of the of the support wall 4, the irrigation chamber 5 comprising irrigation chamber walls 51, and the irrigation chamber walls 51 and the support wall 4 defining a closed irrigation space 54.

In this context irrigation means an artificial process of applying controlled amounts of nutrient rich water solution to the plants 2a,2b to assist in production of crops.

In one embodiment, the irrigation chamber 5 being watertight. In other words, the irrigation chamber 5 is arranged to prevent droplets of the growing liquid 7 leaving the irrigation chamber 5.

In one embodiment, the irrigation chamber 5 being vapour tight. In other words, the irrigation chamber 5 is arranged to prevent misted growing liquid 7 leaving the irrigation chamber 5.

In one embodiment, the irrigation chamber 5 being airtight. In other words, the irrigation chamber 5 is arranged to prevent any form of growing liquid 7 leaving the irrigation chamber 5.

The vertical cultivation system 1 further comprises an irrigation arrangement 6 arranged to provide the root part 21 of the plants 2a, 2b with growing liquid 7.

In one embodiment, the vertical cultivation system 1 further comprises a growing liquid reservoir 52 being provided to a lower part of the irrigation chamber 5, the growing liquid reservoir 52 is arranged to retain growing liquid 7.

In one embodiment, the vertical cultivation system 1 further comprises a growing liquid inlet arrangement 91 arranged to supply additional growing liquid 7 into the vertical cultivation system 1.

In one embodiment, the vertical cultivation system 1 further comprises a growing liquid inlet arrangement 91 arranged to supply additional growing liquid 7 into the growing liquid reservoir 52.

In one embodiment, the vertical cultivation system 1 comprises a growing light arrangement 10 arranged to illuminate the aerial part 21 of the plants 2a, 2b.

In one embodiment, the growing light arrangement 10 being elongated, and the growing light arrangement 10 extends in a direction parallel relative to support wall 4.

In one embodiment, the irrigation chamber 5 comprises an irrigation chamber bottom wall 53 and an irrigation chamber top wall 56, the vertical cultivation system 1 having a longitudinal direction F extending in a direction between the irrigation chamber bottom wall 53 and the irrigation chamber top wall 56, the vertical cultivation system 1 comprises a growing light arrangement 10 arranged to extend parallel to the longitudinal direction F.

In one embodiment, the vertical cultivation system 1 comprises a growing light arrangement 10 arranged to illuminate the aerial part 21 of the plants 2a, 2b.

In one embodiment, the growing light arrangement 10 being elongated, and the growing light arrangement 10 extends in a direction parallel relative to support wall 4.

In one embodiment, the irrigation chamber 5 comprises an irrigation chamber bottom wall 53 and an irrigation chamber top wall 56, the vertical cultivation system 1 having a longitudinal direction F extending in a direction between the irrigation chamber bottom wall 53 and the irrigation chamber top wall 56, the vertical cultivation system 1 comprises a growing light arrangement 10 arranged to extend parallel to the longitudinal direction F.

In one embodiment, the growing light arrangement 10 comprising one or more light sources 11 arranged to extend parallel to the longitudinal direction F.

In one embodiment, the one or more light sources 11 are arranged to provide the plants 2a, 2b with light beams 12 such that the light beams 12 having a light beam upright angle L between the light beams 12 and the support wall 4, and more than 60% of the plants 2a,2b are illuminated with the light beams 12 having the light beam upright angle L between 70 to 110 degrees.

In this context a light beam is a directional projection of light energy radiating from the light source.

In one embodiment, the one or more light sources 11 are arranged to provide the plants 2a, 2b with light beams 12, the light beams 12 extending in a direction horizontal H.

In one embodiment, the one or more light sources 11 are arranged to provide the plants 2a, 2b with light beams 12, and more than 60% of the plants 2a,2b being illuminated with the light beams 12 extending in a direction horizontal H.

In this context the light beam upright angle means an angle in a vertical direction. In other words, the light beam upright angle means an up-down inclination.

In one embodiment, the plants 2a,2b are illuminated with the light beams 12 having the light beam upright angle L between 70 to 110 degrees.

In one embodiment, the growing light arrangement 10 comprises a light source 11 rich in red light.

In one embodiment, the growing light arrangement 10 comprises a light source 11 rich in red and blue light.

In one embodiment, the light source 11 rich in red light are arranged to be turned on during nights.

In one embodiment, the light source 11 rich in red and blue light are arranged to be turned on during nights; or

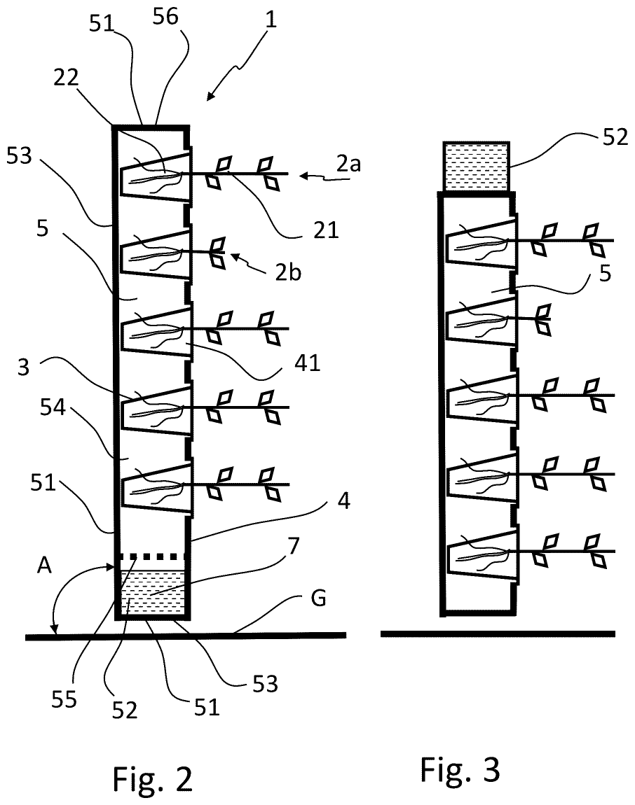

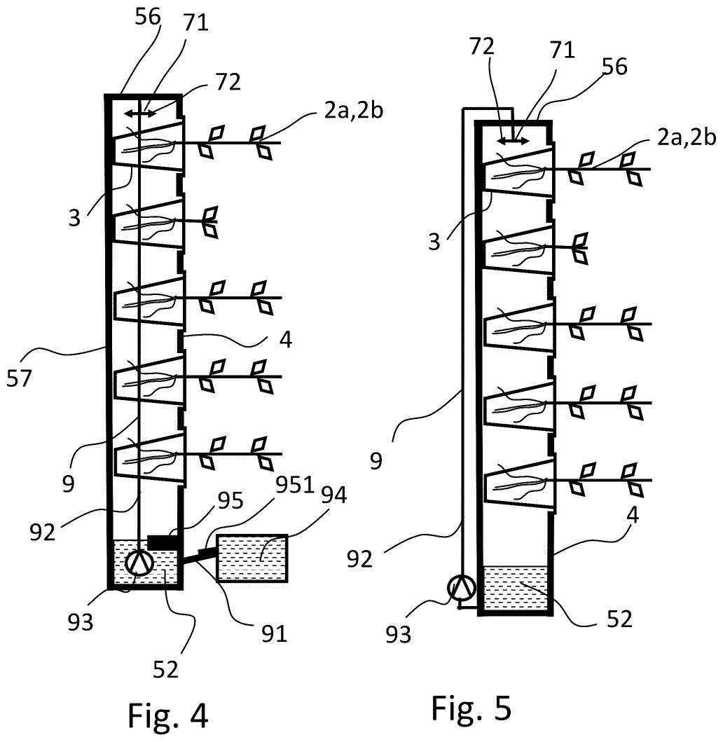

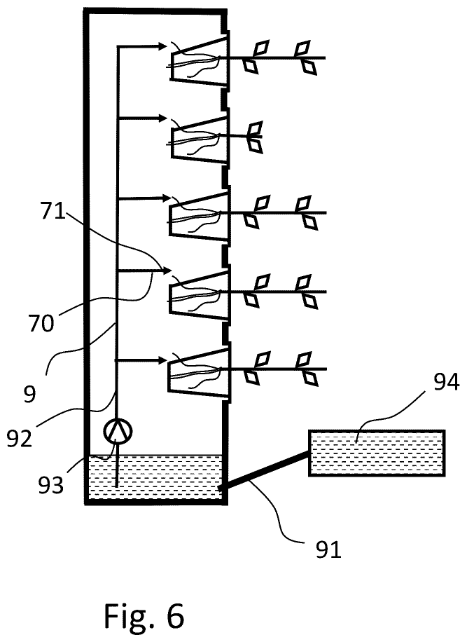

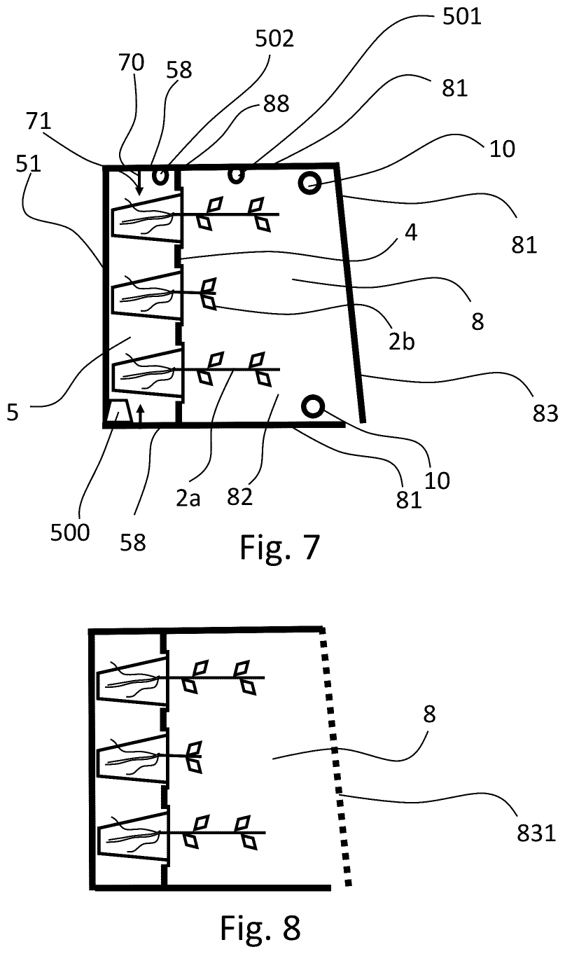

In one embodiment, in red light, and the light source 11 rich in red light is arranged to be turned off when the growing chamber front door 83 shown in FIG. 7 is in an open position.

In one embodiment, the growing light arrangement 10 comprise a light source 11 rich in red and blue light, and the light source 11 rich in red and blue light is arranged to be turned off when the growing chamber front door 83 shown in FIG. 7 is in an open position.

FIG. 2 shows a side view of a vertical cultivation system according to one embodiment of the present invention. In this embodiment, the vertical cultivation system 1 comprises a partitioning wall 55 of the irrigation chamber 5 arranged to provide a growing liquid reservoir 52 underneath the partitioning wall 55. The growing liquid reservoir 52 is arranged to retain growing liquid 7.

In one embodiment, the irrigation chamber walls 51 comprise an irrigation chamber bottom wall 53. The growing liquid reservoir 52 is arranged between the irrigation chamber bottom wall 53 and the partitioning wall 55 of the irrigation chamber 5.

In one embodiment, the partitioning wall 55 of the irrigation chamber 5 is made of liquid permeable material or comprises a liquid permeable structure, such as mesh, net or grid.

In one embodiment, the partitioning wall 55 of the irrigation chamber 5 is made of liquid tight material and the partitioning wall 55 comprises one or more partitioning wall openings.

Thus, excessive growing liquid drops on the partitioning wall and flows through the partitioning wall 55 to the growing liquid reservoir 52.

FIG. 3 shows a side view of a vertical cultivation system according to one embodiment of the present invention. In this embodiment, the vertical cultivation system 1 comprises a growing liquid reservoir 52 above the closed irrigation space 54, the growing liquid reservoir 52 is arranged to retain growing liquid 7.

FIG. 4 shows a side view of a vertical cultivation system according to one embodiment of the present invention. In this embodiment, the irrigation arrangement 6 comprises one or more growing liquid discharge openings 71 arranged to spray growing liquid 7 in the closed irrigation space 54.

In other words, the growing liquid sprayed in the closed irrigation space 54 enters to the root part 22 of the plants 2a,2b.

In this embodiment, the one or more growing liquid discharge openings 71 are provided above the one or more plant holders 3. In other words, the irrigation chamber walls 51 comprises an irrigation chamber top wall 56 and the one or more growing liquid discharge openings 71 are arranged between an uppermost plant 2a,2b and the irrigation chamber top wall 56.

In one embodiment, the one or more growing liquid discharge openings 71 are arranged in connection to the irrigation chamber top wall 56.

In one embodiment, the one or more growing liquid discharge openings 71 comprises a nozzle head 72.

In one embodiment, the one or more growing liquid discharge openings 71 comprises a nozzle head 72 arranged to spray misted growing liquid 7.

In one embodiment, the vertical cultivation system 1 further comprises a liquid circulation arrangement 9 arranged to supply growing liquid 7 from the growing liquid reservoir 52 to the irrigation arrangement 6.

In one embodiment, the growing liquid reservoir 52 is arranged to collect excessive growing liquid 7 sprayed into the irrigation chamber 5.

In the embodiment of FIG. 4, the liquid circulation arrangement 9 comprises a circulation pump 93 and a circulation pipe 92. In the embodiment shown in FIG. 4, the circulation pump 93 and the circulation pipe 92 are arranged inside the closed irrigation space 5.

The circulation pump 93 is arranged into the growing liquid reservoir 52.

In an alternative embodiment, the circulation pump 93 is arranged above the growing liquid reservoir 52 (not shown).

In one embodiment, the irrigation chamber walls 51 comprises an irrigation chamber back wall 57, and the circulation pipe 92 is integrated into the irrigation chamber back wall 57 (not shown). In one embodiment, the vertical cultivation system 1 further comprises a growing liquid source 94.

In one embodiment, the vertical cultivation system 1 further comprises a surface level sensor 95.

The surface level sensor 95 is also arranged to the growing liquid reservoir 52 for measuring surface level or amount of the growing liquid 7 inside the growing liquid reservoir 52.

In one embodiment, the vertical cultivation system 1 comprises a surface level detector 95 arranged to detect a surface level of the growing liquid 7 inside the growing liquid reservoir 52 and the vertical cultivation system 1 comprises a switch 951 arranged to open the growing liquid inlet arrangement 91 when the growing liquid reservoir 52 being decreased to a predefined level.

Growing liquid 7 is arranged to flow from the growing liquid source 94 to the vertical cultivation system 1 when growing liquid 7 inside the growing liquid reservoir 52 being decreased to a predefined level.

FIG. 5 shows a side view of a vertical cultivation system according to one embodiment of the present invention. This embodiment differs from the embodiment shown in FIG. 4 so that the circulation pump 93 and the circulation pipe 92 are arranged outside the closed irrigation space 5.

In should be noted that the embodiment of the vertical cultivation system 1 shown in FIG. 5 may comprise a surface level detector 95 arranged to detect a surface level of the growing liquid 7 inside the growing liquid reservoir 52 and the vertical cultivation system 1 may comprise a switch 951 arranged to open the growing liquid inlet arrangement 91 when the growing liquid reservoir 52 being decreased to a predefined level as shown in FIG. 4.

FIG. 6 shows a side view of a vertical cultivation system according to one embodiment of the present invention. This embodiment differs from the embodiments shown in FIGS. 4 and 5 so that the irrigation arrangement 6 comprises one or more growing liquid discharge openings 71 arranged to spray growing liquid 7 in the closed irrigation space 54, and the one or more growing liquid discharge openings 71 are arranged in connection to the irrigation chamber back wall 57.

In one embodiment, the one or more growing liquid discharge openings 71 are integrated into the irrigation chamber back wall 57 (not shown).

In one embodiment, the one or more growing liquid discharge openings 71 are arranged between the irrigation chamber back wall 57 and the plants 2a, 2b.

The circulation pump 93 is arranged outside the growing liquid reservoir 52. It should be noted that in the embodiments shown in FIGS. 4 and 5 the circulation pump 93 may be arranged outside the growing liquid reservoir 52.

FIG. 7 shows schematically a top view of a vertical cultivation system according to one embodiment of the present invention. The vertical cultivation system 1 comprises a growing chamber 8 provided on the first side of the of the support wall 4. The growing chamber 8 comprises growing chamber walls 81. The growing chamber walls 81 defining a growing space 82.

In one embodiment, the growing chamber walls 81 comprises a growing chamber front door 83, and the growing chamber walls 81 and the support wall 4 defining a growing space 82.

In one embodiment, the growing chamber front door 83 comprises front door hinges arranged to pivotable support the growing chamber front door 83 (not shown).

In one embodiment, the irrigation chamber walls 51 comprises an irrigation chamber side wall 58.

In one embodiment, the irrigation chamber walls 51 comprises irrigation chamber side walls 58.

In one embodiment the irrigation chamber walls 51 comprises an irrigation chamber side wall 58, the irrigation arrangement 6 comprises one or more growing liquid discharge openings 71 arranged to spray growing liquid 7 in the closed irrigation space 54, and the one or more growing liquid discharge openings 71 are arranged in connection to the irrigation chamber side wall 58.

In one embodiment, the vertical cultivation system 1 comprises a growing light arrangement 10 comprising one or more light sources arranged inside the growing chamber 8.

In one embodiment, the irrigation chamber 5 being watertight. In other words, the irrigation chamber 5 is arranged to prevent droplets of the growing liquid 7 leaving the irrigation chamber 5.

In one embodiment, the irrigation chamber 5 being vapour tight. In other words, the irrigation chamber 5 is arranged to prevent misted growing liquid 7 leaving the irrigation chamber 5.

In one embodiment, the growing chamber walls 81 being watertight, the irrigation chamber walls 51 being watertight, and growing chamber walls 81 and the irrigation chamber walls 51 are connected together with a chamber connection 88, and the chamber connection 88 being watertight. In other words, the growing chamber 8 and the irrigation chamber 5 are arranged to prevent droplets of growing liquid 7 leaving the vertical cultivation system 1.

In one embodiment, the growing chamber walls 81 being vapour tight, the irrigation chamber walls 51 being vapour tight, and growing chamber walls 81 and the irrigation chamber walls 51 are connected together with a chamber connection 88, and the chamber connection 88 being vapour tight. In other words, the growing chamber 8 and the irrigation chamber 5 are arranged to prevent misted growing liquid 7 leaving the vertical cultivation system 1.

In one embodiment, the growing chamber walls 81 being airtight, the irrigation chamber walls 51 being airtight, and growing chamber walls 81, the irrigation chamber walls 51 are connected together with a chamber connection 88, and the chamber connection 88 being airtight. In other words, the growing chamber 8 and the irrigation chamber 5 are arranged to prevent any form of growing liquid 7 leaving the vertical cultivation system 1.

It should be noted that both the growing chamber walls 81 and the irrigation chamber walls 51 may be formed from one uniform material.

In one embodiment, the vertical cultivation system 1 comprises a thermal adjustment device 500 arranged to adjust the temperature of the vertical cultivation system 1. The thermal adjustment device 500 may be a heat exchanger, heating device, cooling device or combined heating and cooling device.

In one embodiment, the thermal adjustment device 500 is arranged to adjust the temperature of the growing liquid 7.

In one embodiment, the thermal adjustment device 500 is arranged to adjust the temperature of the growing chamber 8.

In one embodiment, the thermal adjustment device 500 is arranged to adjust the temperature of the irrigation chamber 5. In one embodiment, the vertical cultivation system 1 is further provided with one or more temperature sensors 501 arranged to measure temperature of the vertical cultivation system 1.

In one embodiment, the irrigation chamber 5 is further provided with a chamber humidity sensor 502 arranged to measure humidity in the irrigation chamber 5. The chamber humidity sensor 502 may be any know kind of humidity sensor. The chamber humidity sensor 502 is preferably connected directly or indirectly to the growing liquid discharge openings 70 for controlling and adjusting the growing liquid discharge openings 70 and spraying of growing liquid 7 based on the measurements with the chamber humidity sensor 502. Thus, the measurements with the chamber humidity sensor 502 is utilized for adjusting operation of the growing liquid discharge openings 70.

FIG. 8 shows schematically a top view of a vertical cultivation system according to one embodiment of the present invention. The growing chamber walls 81 comprise a transparent portion 831.

In this context, the transparent portion 831 having the physical property of allowing the transmission of light through a material. In other words, transparent material allowing light to pass through.

In one embodiment, the growing chamber walls 81 comprises a growing chamber front door 83 comprising the transparent portion 831.

It should be noted that all the growing chamber walls may comprise one or more transparent portions 831.

In one embodiment, the support wall 4 being opaque.

FIG. 8 shows schematically a top view of a vertical cultivation system according to one embodiment of the present invention. The growing chamber walls 81 comprise a transparent portion 831.

In this context, the transparent portion 831 having the physical property of allowing the transmission of light through a material. In other words, transparent material allowing light to pass through.

In one embodiment, the growing chamber walls 81 comprises a growing chamber front door 83 comprising the transparent portion 831.

It should be noted that all the growing chamber walls may comprise one or more transparent portions 831.

In one embodiment, the support wall 4 being opaque.

In this context, an opaque object is neither transparent (allowing light to pass through) nor translucent (allowing some light to pass through).

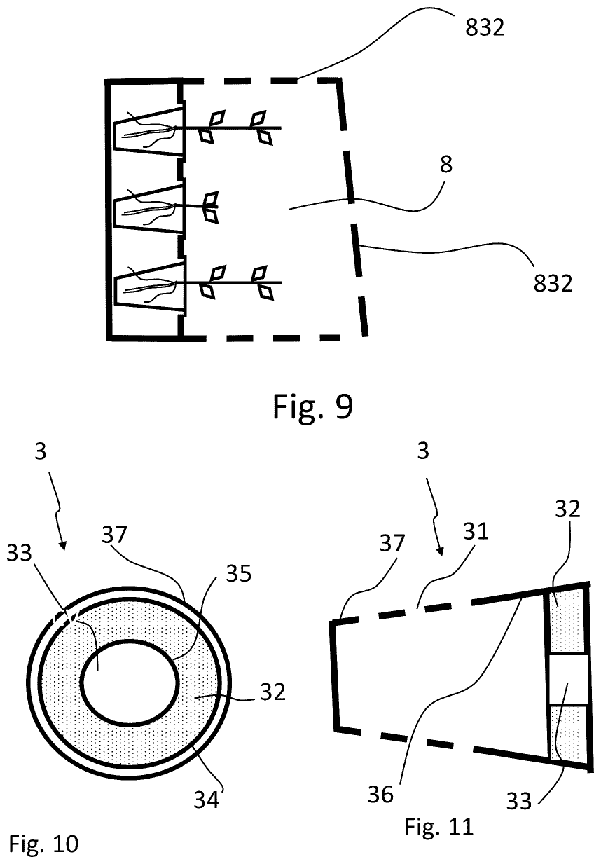

FIG. 9 shows schematically a top view of a vertical cultivation system according to one embodiment of the present invention. The growing chamber walls 81 comprises a translucent portion 832.

It should be noted that only some of the growing chamber walls may comprise one or more translucent portions 832.

In one embodiment, the growing chamber walls 81 comprises a growing chamber front door 83 comprising the translucent portions 832.

In this context, a translucent material means material which allows some light to pass through.

FIGS. 10 and 11 shows schematically a one or more plant holders of a vertical cultivation system according to one embodiment of present invention.

In one embodiment, the one or more plant holders 3 comprise a root container 37 comprising one or more irrigation openings 31. The one or more irrigation openings 31 are arranged to pass growing liquid 7 inside the one or more plant holders 3.

In one embodiment, the root container 37 being a pot.

In one embodiment, the root container 37 being a bag.

In one embodiment, one or more plant holders 3 comprise a plant support 32.

In one embodiment, the plant support 32 comprises or provides a plant support opening 33 through which the plant 2a,2b is placed.

The plant support 32 having a plant support outer surface 34. The one or more plant holders 37 having a plant holder inner surface 36. The plant support outer surface 34 of is placed against the plant holder inner surface. The plant 2a,2b is placed against the inner surface 35 of the plant support 32 defining the plant support opening 33. The plant support 32 is made of resilient material such as foam rubber or foam plastic or neoprene or the like resilient material. The resilient characteristic of the plant support 32 enables the plant support 32 to be compressed when the plant 2a,2b grows without harming the plant 2a,2b. Further, the resilient characteristic enables the plant support 32 to be tightly pressed and sealed against the inner surface 36 of the one or more plant holders 3 and against the plant 2a,2b such that light is prevented from entering the irrigation chamber 5 via the plant support opening 33.

In one embodiment, a support wall 4 comprising one or more support openings 41 provided with the plant support 32.

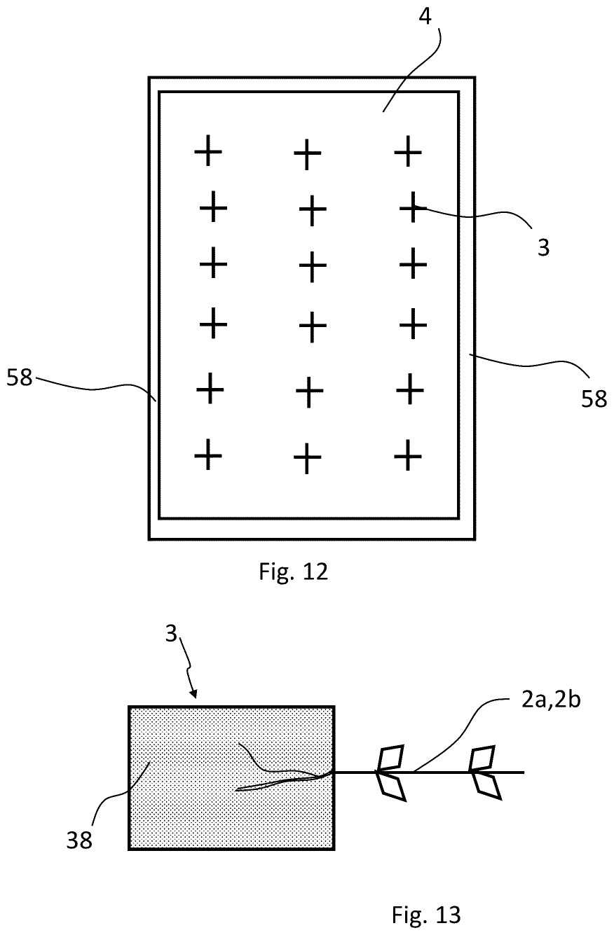

FIG. 12 shows schematically a front view of a vertical cultivation system according to one embodiment of the present invention.

In this embodiment the one or more plant holders 3 are provided to the support wall 4.

In one embodiment, the one or more plant holders 3 being an integral part of the support wall 4. In other words, the one or more support openings 41 are arranged to support the plant 2a,2b.

FIG. 13 shows schematically a side view of a plan holder of a vertical cultivation system according to one embodiment of present invention.

In this embodiment, the one or more plant holders 3 comprise a holder media 38. In other words, the holder media is arranged to receive the root part 11 and the holder media 38 is supported on the one or more support openings 41.

In one embodiment, the holder media 38 is made of paper or a sponge or a peat or any combination thereof.

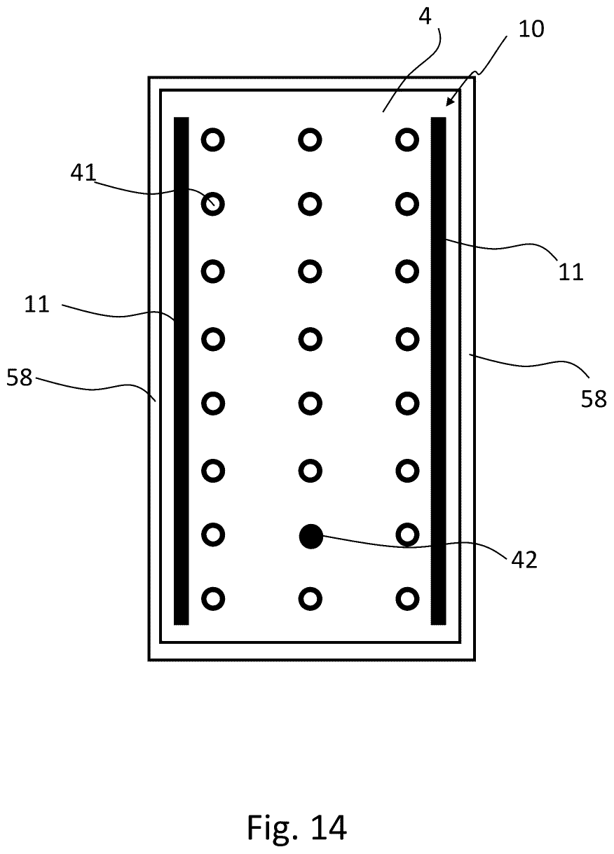

FIG. 14 shows schematically a front view of a vertical cultivation system according to one embodiment of the present invention.

The vertical cultivation system 1 comprises one or more support opening covers 42. The one or more support opening covers 42 are arranged to cover such the one or more support openings 41 which are without the one or more plant holders 3.

Based on the above mentioned, it should be noted that different embodiments of FIGS. 1 to 12 may combined in any possible suitable manner for implementing the present invention. Therefore, the one or more plant holders 3, the support wall 4, the irrigation chamber 5, the irrigation chamber walls 51, the closed irrigation space 54, the irrigation arrangement 6, the growing chamber 8, growing chamber walls 81, the growing space 82, the growing chamber front door 83, the growing liquid reservoir 52, the partitioning wall 55, the growing liquid reservoir 52, the one or more growing liquid discharge openings 71, the nozzle head 72, the liquid circulation arrangement 9, the growing liquid inlet arrangement 91, the growing liquid source 94, the transparent portion 831, the translucent portion 832, the growing light arrangement 10, the one or more light sources 11, the plants 2a, 2b, the plant support 32, the thermal adjustment device 500, one or more temperature sensors 501, the chamber humidity sensor 502, the surface level detector 95 and the one or more support opening covers 42 disclosed above and in FIGS. 1 to 12 may be combined in any suitable manner for forming the vertical cultivation system 1 according to the present invention.

Furthermore, the vertical cultivation system 1 comprises a control unit (not shown), which may be computer, computation unit or device comprising at least one processor and a memory.

One or more of the following are connected to the control unit: the one or more growing liquid discharge openings 71, the nozzle head 72, the liquid circulation arrangement 9, the growing liquid inlet arrangement 91, the growing liquid source 94, the surface level detector 95, the growing light arrangement 10, the one or more light sources 11, the thermal adjustment device 500, one or more temperature sensors 501 and the chamber humidity sensor 502.

The present invention further provides a method for growing of plants 2a, 2b having an aerial part 21 and a root part 22 in a vertical cultivation system 1.

The vertical cultivation system 1 utilized in the method preferably corresponds the above in relation to FIGS. 1 to 14 disclosed vertical cultivation system 1.

The method comprises inserting the plants 2a,2b to the one or more support openings 41 of the plant a support wall 4.

In one embodiment, inserting the one or more plant holders 3 to the one or more support openings 41 of the plant a support wall 4 such that the one or more plant holders 3 comprising plantlets of the plants 2a,2b.

The method further comprises using the irrigation arrangement 6 to provide the root part of the plants 2a, 2b with growing liquid 7.

The method further comprises harvesting.

In one embodiment, the method further comprises removing between 0.1 to 10% of the one or more plant holders 3 with the plant 2a,2b from the vertical cultivation system 1 for providing a partially harvested vertical cultivation system 1 comprising one or more harvested support openings 41.

In one embodiment, the method further comprises removing between 0.1 to 30% of the one or more plant holders 3 with the plant 2a,2b from the vertical cultivation system 1 for providing a partially harvested vertical cultivation system 1 comprising one or more harvested support openings 41.

In one embodiment, the method comprises picking between 0.1 to 10% of plants 2a,2b for providing a partially harvested vertical cultivation system 1.

In one embodiment, the method comprises picking between 0.1 to 30% of the plants (2a,2b for providing a partially harvested vertical cultivation system 1.

In one embodiment, the method further comprises after harvesting a step of inserting one or more plant holders 3 with the plant 2a,2b to the one or more harvested support openings 41.

In one embodiment, the vertical cultivation system 1 comprises one or more support opening covers 42, and the method further comprises covering the one or more harvested support openings 41 with the one or more support opening covers 42.

In one embodiment, the method further comprises measuring surface level of the growing liquid 7 the growing liquid reservoir 52 and adding new growing liquid 7 based on the surface level measurement. Accordingly, the addition of the new growing liquid 7 into the system 1 is carried out based on the measurement amount of growing liquid 7 in the system 1 and in the growing liquid reservoir 52.

In one embodiment the method comprises providing the one or more plant holders 3 with plantlet of the plant 2a,2b before inserting the one or more plant holders 3 to the one or more support openings 41.

In one embodiment, the method further comprises illuminating the aerial part 21 of the plant 2a,2b a first predetermined illuminating period in a day with the growing light arrangement 10. The first predetermined illuminating period is between 8 to 16 hours a day.

In one embodiment, the method further comprises providing a first predetermined concentration of nitrogen (N), phosphorus (P) and potassium (K) in the growing liquid 7, and spraying the growing liquid 7 having the first predetermined concentration of nitrogen (N), phosphorus (P) and potassium (K) in the closed irrigation space 54 to the root part 22 of the plant 2a,2b.

In one embodiment, the method comprises adjusting the temperature of the vertical cultivation system 1 by utilizing one or more thermal adjustment devices 500. The temperature is adjusted by heating or cooling or by heating and cooling.

The invention has been described above with reference to the examples shown in the figures. However, the invention is in no way restricted to the above examples but may vary within the scope of the claims.

1.-15. (canceled)

16. A vertical cultivation system for growing plants having an aerial part and a root part, wherein the vertical cultivation system comprises:
one or more plant holders for holding the plant,
a support wall comprising one or more support openings, the support wall extends transverse relative to the surface of the ground, and the support wall is arranged to support the one or more plant holders such that the plant extends through the one or more support openings and such that the aerial part is arranged on a first side of the support wall and the root part is arranged on a second side of the support wall,
an irrigation chamber provided on the second side of the support wall, the irrigation chamber comprising irrigation chamber walls, and the irrigation chamber walls and the support wall defining a closed irrigation space, and
an irrigation arrangement arranged to provide the root part of the plants with growing liquid.

17. The vertical cultivation system according to claim 16, wherein:
the vertical cultivation system comprises a growing chamber provided on the first side of the of the support wall, the growing chamber comprising growing chamber walls defining a growing space; or
the vertical cultivation system comprises a growing chamber provided on the first side of the of the support wall, the growing chamber comprising growing chamber walls, the growing chamber walls comprise a growing chamber front door, and the growing chamber walls and the support wall defining a growing space.

18. The vertical cultivation system according to claim 16, wherein:
the vertical cultivation system comprises a growing liquid reservoir; or
the vertical cultivation system comprises a growing liquid reservoir being provided to a lower part of the irrigation chamber, the growing liquid reservoir is arranged to retain growing liquid; or
the vertical cultivation system comprises a partitioning wall of the irrigation chamber arranged to provide a growing liquid reservoir underneath the partitioning wall, the growing liquid reservoir is arranged to retain growing liquid; or
the vertical cultivation system comprises a growing liquid reservoir above the closed irrigation space, the growing liquid reservoir is arranged to retain growing liquid; or
the vertical cultivation system comprises a separate growing liquid reservoir arranged to retain growing liquid.

19. The vertical cultivation system according to claim 16, wherein:
the irrigation arrangement comprises one or more growing liquid discharge openings arranged to spray growing liquid in the closed irrigation space; or
the irrigation arrangement comprises one or more growing liquid discharge openings arranged to spray growing liquid in the closed irrigation space, the one or more growing liquid discharge openings are provided above the one or more plant holders; or
the irrigation arrangement comprises one or more growing liquid discharge openings arranged to spray growing liquid in the closed irrigation space, the one or more growing liquid discharge openings are provided beside the one or more plant holders; or
the irrigation chamber walls comprises an irrigation chamber top wall, the irrigation arrangement comprises one or more growing liquid discharge openings arranged to spray growing liquid in the closed irrigation space, and the one or more growing liquid discharge openings are arranged in connection to the irrigation chamber top wall; or
the irrigation chamber walls comprises an irrigation chamber back wall, the irrigation arrangement comprises one or more growing liquid discharge openings arranged to spray growing liquid in the closed irrigation space, and the one or more growing liquid discharge openings are arranged in connection to the irrigation chamber back wall; or
the irrigation chamber walls comprises an irrigation chamber side wall, the irrigation arrangement comprises one or more growing liquid discharge openings arranged to spray growing liquid in the closed irrigation space, and the one or more growing liquid discharge openings are arranged in connection to the irrigation chamber side wall; or
the irrigation arrangement comprises a misting device arranged to provide the root part of the plants with misted growing liquid.

20. The vertical cultivation system according to claim 19, wherein:
the one or more growing liquid discharge openings comprise a nozzle; or
the one or more growing liquid discharge openings comprise a nozzle comprising a nozzle head arranged to spray growing liquid; or
the one or more growing liquid discharge openings comprise a nozzle comprises a nozzle comprising a nozzle head arranged to spray misted growing liquid.

21. The vertical cultivation system according to claim 16, wherein:
the vertical cultivation system comprises a liquid circulation arrangement arranged to supply growing liquid from the growing liquid reservoir to the irrigation arrangement; or
the vertical cultivation system comprises a liquid circulation arrangement arranged to supply growing liquid from the growing liquid reservoir to the irrigation arrangement, and the growing liquid reservoir is arranged to collect excessive growing liquid sprayed into the irrigation chamber; or
the vertical cultivation system comprises a liquid circulation arrangement arranged to supply growing liquid from the growing liquid reservoir to the irrigation arrangement, the growing liquid reservoir is arranged to collect excessive growing liquid sprayed into the irrigation chamber, and the vertical cultivation system comprises a growing liquid inlet arrangement arranged to supply additional growing liquid into the vertical cultivation system; or
the vertical cultivation system comprises a liquid circulation arrangement arranged to supply growing liquid from the growing liquid reservoir to the irrigation arrangement, the growing liquid reservoir is arranged to collect excessive growing liquid sprayed into the irrigation chamber, the vertical cultivation system further comprises a growing liquid source, and the vertical cultivation system further comprises a growing liquid inlet arrangement arranged to supply additional growing liquid from the growing liquid source into the vertical cultivation system, the vertical cultivation system comprises a surface level detector arranged to detect a surface level of the growing liquid inside the growing liquid reservoir, the vertical cultivation system comprises a switch arranged to open the growing liquid inlet arrangement when the surface level of the growing liquid inside the growing liquid reservoir being decreased to a predefined level.

22. The vertical cultivation system according to claim 17, wherein:
the growing chamber walls comprise a transparent portion or translucent portion; or
the growing chamber walls comprises a transparent portion; or
the growing chamber walls comprises a translucent portion; or
the growing chamber walls comprise a transparent portion or translucent portion and the support wall being opaque; or
the growing chamber walls comprises a transparent portion and the support wall being opaque; or
the growing chamber walls comprises a translucent portion and the support wall being opaque; or
the growing chamber walls, the irrigation chamber walls, and the support wall being opaque.

23. The vertical cultivation system according to claim 16, wherein:
the vertical cultivation system comprises a growing light arrangement arranged to illuminate the aerial part of the plants; or
the vertical cultivation system comprises a growing light arrangement facing toward the first side of support wall for illuminating the aerial part of the plants; or
the irrigation chamber comprises an irrigation chamber bottom wall and an irrigation chamber top wall, the vertical cultivation system having a longitudinal direction extending in a direction between the irrigation chamber bottom wall and the irrigation chamber top wall, the vertical cultivation system comprises a growing light arrangement arranged to extend parallel to the longitudinal direction; or
the irrigation chamber comprises an irrigation chamber bottom wall and an irrigation chamber top wall, the vertical cultivation system having a longitudinal direction extending in a direction between the irrigation chamber bottom wall and the irrigation chamber top wall, the vertical cultivation system comprises a growing light arrangement comprising one or more light sources arranged to extend parallel to the longitudinal direction; or
the vertical cultivation system comprises the growing light arrangement comprising one or more light sources, the one or more light sources are arranged to provide the plants with light beams such that the light beams having a light beam upright angle between the light beams and the support wall, and more than 60% of the plants being illuminated with the light beams having the light beam upright angle between 70 to 110 degrees; or
the irrigation chamber comprises an irrigation chamber bottom wall and an irrigation chamber top wall, the vertical cultivation system having a longitudinal direction extending in a direction between the irrigation chamber bottom wall and the irrigation chamber top wall, the vertical cultivation system comprises a growing light arrangement comprising one or more light sources arranged to extend parallel to the longitudinal direction, the one or more light sources are arranged to provide the plants with light beams, the light beams having a light beam upright angle between the light beams and the support wall and more than 60% of the plants being illuminated with the light beams having the light beam upright angle between 70 to 110 degrees; or
the irrigation chamber comprises an irrigation chamber bottom wall and an irrigation chamber top wall, the vertical cultivation system having a longitudinal direction extending in a direction between the irrigation chamber bottom wall and the irrigation chamber top wall, the vertical cultivation system comprises a growing light arrangement comprising one or more light sources arranged to extend parallel to the longitudinal direction, the one or more light sources are arranged to provide the plants with light beams, and more than 60% of the plants being illuminated with the light beams extending in a direction horizontal.

24. The vertical cultivation system according to claim 23, wherein:
the growing light arrangement comprises a light source; or
the growing light arrangement comprises a light source and a timing device arranged to turn on the light source at intervals; or
the growing light arrangement comprises a light source arranged to be turned on constantly; or
the growing light arrangement comprises a light source rich in red light; or
the growing light arrangement comprises a light source rich in red and blue light; or
the growing light arrangement comprise a light source rich in red light, and the light source rich in red light is arranged to be turned on during nights; or
the growing light arrangement comprise a light source rich in red and blue light, and the light source rich in red and blue light is arranged to be turned on during nights; or
the growing light arrangement comprise a light source rich in red light, and the light source rich in red light is arranged to be turned off when the growing chamber front door is in an open position; or
the growing light arrangement comprise a light source rich in red and blue light, and the light source rich in red and blue light is arranged to be turned off when the growing chamber front door is in an open position.

25. The vertical cultivation system according to claim 16, wherein:
the one or more plant holders are provided to the support wall; or
the one or more plant holders being an integral part of the support wall; or
the one or more plant holders comprise a root container; or
the one or more plant holders comprise a root container comprising one or more irrigation openings and a plant support; or
the one or more plant holders comprise a holder media; or
the one or more plant holders comprise a plant support; or
the one or more plant holders being removable from the system 8.

26. A method for growing of plants having an aerial part and a root part in a vertical cultivation system, wherein the vertical cultivation system comprises:
one or more plant holders for holding the plant;
a support wall comprising one or more support openings, the support wall extends transverse relative to the surface of the ground, and the support wall is arranged to support the one or more plant holders such that the plants extends through one or more support openings and such that the aerial part is arranged on a first side of the support wall and the root part is arranged on a second side of the support wall;
an irrigation chamber provided on the second side of the support wall, the irrigation chamber comprising irrigation chamber walls, and the irrigation chamber walls and the support wall defining a closed irrigation space; and
an irrigation arrangement arranged to provide the root part of the plants with growing liquid, and
that the method comprises:
inserting the plants to the one or more support openings of the plant a support wall;
irrigating the root part of the plant with the irrigation arrangement; and
harvesting.

27. The method according to claim 26, wherein the step of harvesting further comprises:
removing between 0.1 to 10% of the one or more plant holders with the plant from the vertical cultivation system for providing a partially harvested vertical cultivation system comprising one or more harvested support openings; or
removing between 0.1 to 30% of the one or more plant holders with the plant from the vertical cultivation system for providing a partially harvested vertical cultivation system comprising one or more harvested support openings; or
picking between 0.1 to 10% of plants for providing a partially harvested vertical cultivation system; or
picking between 0.1 to 30% of the plants for providing a partially harvested vertical cultivation system.

28. The method according to claim 26, wherein:
the method comprises after harvesting a step of inserting one or more plant holders with the plant to the one or more harvested support openings; or
the vertical cultivation system comprises one or more support opening covers, and the method comprises after harvesting a step of covering the one or more harvested support openings with the one or more support opening covers.

29. The method according to claim 26, wherein:
the plants having the root part exposed to growing liquid;
the plants having the root part exposed to growing liquid and the plants having a consumable aerial part; or
the plants having a consumable aerial part; or
the plants having a consumable aerial part, and the plants being in different growth stages; or
the plants having the root part exposed to growing liquid, the plants having a consumable aerial part, and the plants being in different growth stages between plantlet and harvest; or
the plants having the root part exposed to growing liquid, the plants having a consumable aerial part, and the plants and the plants being different species.

30. The method for growing of plants having an aerial part and a root part in a vertical cultivation system, wherein the vertical cultivation system comprises:
one or more plant holders for holding the plant;
a support wall comprising one or more support openings, the support wall extends transverse relative to the surface of the ground, and the support wall is arranged to support the one or more plant holders such that the plants extends through one or more support openings and such that the aerial part is arranged on a first side of the support wall and the root part is arranged on a second side of the support wall;
an irrigation chamber provided on the second side of the support wall, the irrigation chamber comprising irrigation chamber walls, and the irrigation chamber walls and the support wall defining a closed irrigation space; and
an irrigation arrangement arranged to provide the root part of the plants with growing liquid, and
that the method comprises:
inserting the plants to the one or more support openings of the plant a support wall;
irrigating the root part of the plant with the irrigation arrangement; and
harvesting wherein the method being carried out with a vertical cultivation system according to claim 16.
